(19) United States
(12) Patent Application Publication
(10) Pub. No.: US 2021/0182417 A1
(43) Pub. Date: Jun. 17, 2021

(54) METHOD AND SYSTEM FOR SECURE INGESTION OF METRICS OF TIME SERIES DATA

(71) Applicant: VMware, Inc., Palo Alto, CA (US)

(72) Inventors: Clement Pang, Sunnyvale, CA (US); Lakshmi Ganesh N.R. Kapatralla, Sunnyvale, CA (US); Jason Hsi-Chieh Bau, Palo Alto, CA (US); Mayan Weiss, San Jose, CA (US); Lior Matkovitch, San Jose, CA (US)

(73) Assignee: VMware, Inc., Palo Alto, CA (US)

(21) Appl. No.: 16/713,672

(22) Filed: Dec. 13, 2019

(51) Int. Cl. G06F 21/62; G06F 16/2458

(52) U.S. Cl. CPC G06F 21/6227; G06F 16/2477

(57) ABSTRACT

In a method for secure ingestion of metrics of time series data, an ingestion request for ingesting at least one metric of time series data is received, the ingestion request including an identifier. The ingestion request is validated against a security policy according to the identifier. The ingestion request is updated to exclude any metric indicated in the security policy as excluded according to the identifier. The at least one metric of time series data is ingested according to the ingestion request.

### BACKGROUND

Management, monitoring, and troubleshooting in dynamic environments, both cloud-based and on-premises products, is increasingly important as the popularity of such products continues to grow. Monitoring tools collect information (both sensitive and non-sensitive) in the form of metrics, logs, traces, histograms, etc., about customer machines, applications, services, and in some cases, the end users. Even disparate sources of information when analyzed in totality can significantly impact the customer business. Moreover, whenever any type of data is accessed, e.g., collected, processed, or analyzed, an application would need to confirm to the information security and compliance standards established or adopted by the customer's organization. Customers that want to monitor classified data seek enhanced information security policies to be available in monitoring systems so that they can fully comply with data privacy and regulations from all end points.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 is a block diagram illustrating a system for securing access to metrics of time series data, in accordance with embodiments.

FIG. 2 is a block diagram illustrating an example ingestion node for secure ingestion of data points of time series data, in accordance with embodiments.

FIG. 3A illustrates an example prioritized list of a metrics security policy for controlling ingestion of metrics into a time series database, according to embodiments.

FIG. 3B illustrates an example data flow diagram for secure ingestion of metrics into a time series database, according to embodiments.

FIG. 4 is a block diagram illustrating an example query node for secure querying of metrics of a time series database, in accordance with embodiments.

FIG. 5 is a block diagram illustrating an example query node for secure access to metrics of a time series database, in accordance with embodiments.

FIG. 6A illustrates an example prioritized list of a metrics security policy for controlling access to metrics of a time series database, according to embodiments.

FIG. 6B illustrates an example data flow diagram for secure querying of metrics of a time series database, according to embodiments.

FIG. 6C illustrates an example data flow diagram for secure access to metrics of a time series database, according to embodiments.

FIGS. 7A through 7D illustrate screen shots of an example metric security policy creation user interface, according to embodiments.

FIG. 8 is a block diagram of an example computer system upon which embodiments of the present invention can be implemented.

FIG. 9 illustrates a flow diagram for secure ingestion of metrics of time series data, according to various embodiments.

FIG. 10 illustrates a flow diagram for secure access to metrics of time series data, according to various embodiments.

FIG. 11 illustrates a flow diagram for secure querying of metrics of time series data, according to various embodiments.

### DETAILED DESCRIPTION OF CERTAIN EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “validating,” “updating,” “returning,” “generating,” “executing,” “ingesting,” “comparing,” “determining,” “performing,” or the like, refer to the actions and processes of an electronic computing device or system such as: a host processor, a processor, a memory, a cloud-computing environment, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

Example embodiments described herein improve the performance of computer systems by improving the security of time series data. Data security is a concern in organizations of all sizes. In systems capable of monitoring large volumes of data, such as time series data monitoring systems, securing data presents particular challenges. Time series data typically includes various metrics, where different metrics may have different security requirements. For example, metrics related to finance may be considered sensitive and restricted to finance officers, while other metrics, such as infrastructure operations, may be less sensitive. Moreover, without securing access to the metrics data itself, and instead relying on conventional data security, the metrics stored may be discoverable to unauthorized users. Embodiments described herein provide for securing metrics of time series data, at ingestion and/or at retrieval, to avoid discoverability to unauthorized users.

In some embodiments, a method for secure ingestion of metrics of time series data is provided. An ingestion request for ingesting at least one metric of time series data is received, the ingestion request including an identifier. In one embodiment, the ingestion request is received via a proxy. In another embodiment, the ingestion request is received via a direct ingestion. In another embodiment, the ingestion request is received via a cloud services, e.g., integrations such as Amazon Web Services (AWS), Azure, etc. In one embodiment, the identifier includes a token. The ingestion request is validated against a metric ingestion security policy according to the identifier. In one embodiment, the metric ingestion security policy includes a prioritized list of security policies for ingestion, wherein the security policies are enforced according to an order of the prioritized list. In one embodiment, validating the ingestion request against the metric ingestion security policy according to the identifier includes comparing the at least one metric of the ingestion request to the metric ingestion security policy. It is determined whether the metric ingestion security policy authorizes ingestion of the at least one metric for the identifier. Provided the metric ingestion security policy does not authorize ingestion of the at least one metric for the identifier, it is determined that ingestion of the at least one metric is excluded. The ingestion request is updated to exclude any metric indicated in the metric ingestion security policy as excluded according to the identifier. The at least one metric of time series data is ingested according to the ingestion request. In one embodiment, the at least one metric of time series data is ingested into at least one time series database.

In some embodiments, a method for secure access to metrics of time series data is provided. An access request for accessing at least one metric of time series data is received, the access request including an identifier. In one embodiment, the access request includes a request for displaying a plurality of metrics. In another embodiment, the access request includes a query request for accessing the at least one metric of time series data. In one embodiment, the identifier includes at least one of: an account, a role, and a group. The access request is validated against a metric access security policy according to the identifier. In one embodiment, the metric access security policy includes a prioritized list of rules for accessing metrics from at least one time series database. The access request is updated to exclude any metric indicated in the metric access security policy as excluded according to the identifier. Results of the access request are returned. In some embodiments, the access request includes a request for displaying a plurality of metrics. In other embodiments, the access request includes a query request for accessing the at least one metric of time series data.

In one embodiment, where the access request includes a query request for accessing the at least one metric of time series data, a query plan for accessing the at least one metric of time series data from at least one time series database is generated based on the query request. In one embodiment, the query plan is validated against the metric access security policy according to the identifier. In one embodiment, the query plan is updated to exclude any metric indicated in the metric access security policy as excluded according to the identifier. In one embodiment, the query plan is executed against the at least one time series database. In one embodiment, the results of the query plan are returned. In one embodiment, the results include key value pairs from at least one time series database.

### Example System for Secure Ingestion and Access to Metrics of Time Series Data

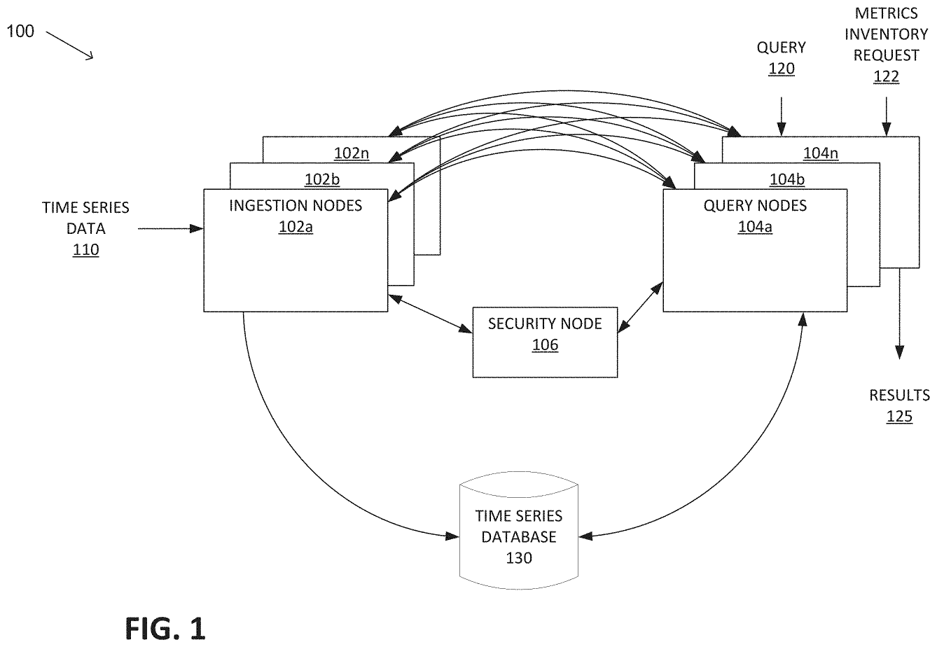

FIG. 1 is a block diagram illustrating an embodiment of a system 100 for adapting time series database schema of time series database 130, according to embodiments. System 100 is a distributed system including multiple ingestion nodes 102a through 102n (collectively referred to herein as ingestion nodes 102), multiple query nodes 104a through 104n (collectively referred to herein as query nodes 104), and security node 106. Time series 110 is received at ingestion nodes 102 and stored within time series database 130. Query nodes 104 are configured to receive at least one query 120 for querying against time series database 130. Query nodes 104 are also configured to receive metric inventory request 122. Results 125 of query 120 are returned upon execution of query 120. Results 125 of metric inventory request 122 are also returned upon execution of metric inventory request.

Security node 106 includes metrics security policies for securing access to metrics, e.g., telemetry data based on an identifier (e.g., a role, group, or account). In some embodiments, a metrics security policy includes a prioritized list of security policies or rules, for accessing metrics. The metrics security policy can be ordered in such a way that the rule with a higher priority takes precedence, e.g., priority, and gets enforced according to the ordering of the rules. In some embodiments, security node 106 is configured to secure access to metrics of time series database 130 responsive to receiving query 120 or metrics inventory request 122 at query nodes 104. In some embodiments, security node 106 is configured to secure ingestion of metrics to time series database 130 responsive to receiving time series data 110 at ingestion nodes 102.

It should be appreciated that system 100 can include any number of ingestion nodes 102 and multiple query nodes 104. Ingestion nodes 102 and query nodes 104 can be distributed over a network of computing devices in many different configurations. For example, the respective ingestion nodes 102 and query nodes 104 can be implemented where individual nodes independently operate and perform separate ingestion or query operations. In some embodiments, multiple nodes may operate on a particular computing device (e.g., via virtualization), while performing independently of other nodes on the computing device. In other embodiment, many copies of the service (e.g., ingestion or query) are distributed across multiple nodes (e.g., for purposes of reliability and scalability).

Time series data 110 is received at at least one ingestion node 102a through 102n. In some embodiments, time series data includes a numerical measurement of a system or activity that can be collected and stored as a metric (also referred to as a “stream”). For example, one type of metric is a CPU load measured over time. Other examples include, service uptime, memory usage, etc. It should be appreciated that metrics can be collected for any type of measurable performance of a system or activity. Operations can be performed on data points in a stream. In some instances, the operations can be performed in real time as data points are received. In other instances, the operations can be performed on historical data. Metrics analysis include a variety of use cases including online services (e.g., access to applications), software development, energy, Internet of Things (loT), financial services (e.g., payment processing), healthcare, manufacturing, retail, operations management, and the like. It should be appreciated that the preceding examples are non-limiting, and that metrics analysis can be utilized in many different types of use cases and applications.

In accordance with some embodiments, a data point in a stream (e.g., in a metric) includes a name, a source, a value, and a time stamp. Optionally, a data point can include one or more tags (e.g., point tags). For example, a data point for a metric may include:
A name—the name of the metric (e.g., CPU_idle, service.uptime)
A source—the name of an application, host, container, instance, or other entity generating the metric (e.g., web_server_1, app1, app2)
A value—the value of the metric (e.g., 99% idle, 1000, 2000)
A timestamp—the timestamp of the metric (e.g., 1418436586000)
One or more point tags (optional)—custom metadata associated with the metric (e.g., location=las_vegas, environment=prod)

Ingestion nodes 102 are configured to process received data points of time series data 110 for persistence and indexing. In some embodiments, ingestion nodes 102 forward the data points of time series data 110 to time series database 130 for storage. In some embodiments, the data points of time series data 110 are transmitted to an intermediate buffer for handling the storage of the data points at time series database 130. In one embodiment, time series database 130 can store and output time series data, e.g., TS1, TS2, TS3, etc. The data can include times series data, which may be discrete or continuous. For example, the data can include live data fed to a discrete stream, e.g., for a standing query. Continuous sources can include analog output representing a value as a function of time. With respect to processing operations, continuous data may be time sensitive, e.g., reacting to a declared time at which a unit of stream processing is attempted, or a constant, e.g., a 10V signal. Discrete streams can be provided to the processing operations in timestamp order. It should be appreciated that the time series data may be queried in real-time (e.g., by accessing the live data stream) or offline processing (e.g., by accessing the stored time series data).

In some embodiments, security node 106 is configured to secure ingestion of time series data 110 by validating a request to ingest time series data 110. It should be appreciated that in accordance with various embodiments, ingestion nodes 102 may receive time series data 110 that time series database 130 is not authorized to ingest (e.g., store). For example, in a multi-tenant cluster, a first tenant may receive but not be authorized to ingest time series data 110 for a second tenant. Moreover, in another example, a parent organization of a multi-tenant cluster may be authorized to ingest time series data 110 for all sub-tenants, while the sub-tenants are only authorized to their own time series data 110.

In some embodiments, security node 106 is configured to secure access to metrics of time series database 130 by validating a query 120 and/or metrics inventory request 122. It should be appreciated that in accordance with various embodiments, query nodes 104 may receive a query 120 or a metrics inventory request 122 that includes metrics that the querying party (e.g., role, group, or account) is not authorized to access. For example, an organization may deny access to metrics (e.g., finance-related metrics) to certain employees or contractors, while granting access to certain authorized employees (e.g., a chief financial officer). By blocking access to the metrics, the described embodiments block discoverability as well as access to metrics, according the metrics security policy.

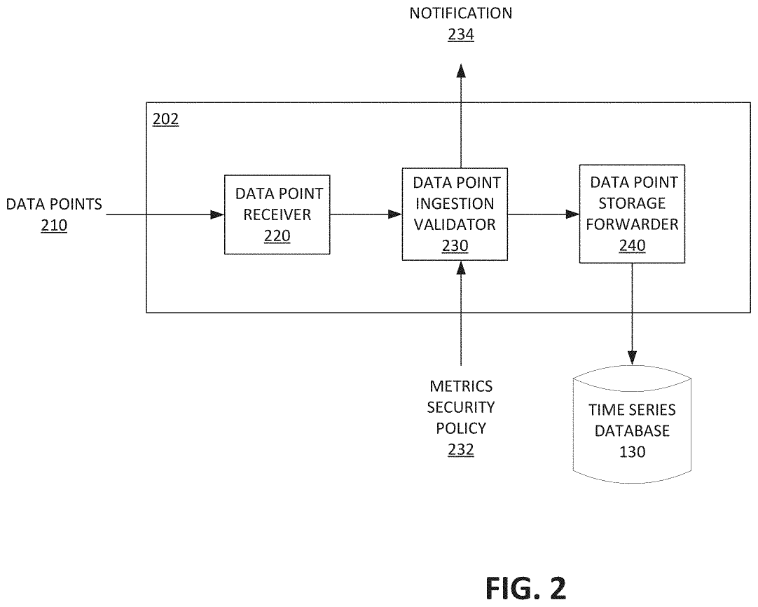

FIG. 2 is a block diagram illustrating an embodiment of an example ingestion node 202 (e.g., one of ingestion nodes 102a through 102n of FIG. 1) for secure ingestion of data points 210 of time series data (e.g., time series data 110) for storage in time series database 130 according to a metrics security policy. In one embodiment, ingestion node 202 receives data points 210, determines whether ingestion of data points 210 is authorized according to the metrics security policy of security node 106, and ingests the authorized data points 210 into time series database 130.

In the example shown in FIG. 2, data points 210 are received. In one embodiment, time series data including data points 210 is received from an application or system. Data points 210 are received at data point receiver 220. Data point receiver 220 is configured to forward data points 210 to data point ingestion validator 230. Data point ingestion validator 230 receives data points 210 and metrics security policy 232 (e.g., from security node 106). Data point ingestion validator 230 compares data points 210 to metrics security policy 232 to determine whether data points 210 (e.g., individually or grouped) are authorized for ingestion into time series database 130. Provided data points 210 are authorized for ingestion into time series database 130, data point ingestion validator 230 forwards the data points 210 to data point storage forwarder 240. Data point storage forwarder 240 stores data points 210 in time series database 130 according to the specifications of time series database 130 (e.g., a schema). In some embodiments, provided data points 210 are not authorized for ingestion into time series database 130, data point ingestion validator 230 generates a notification 234 (e.g., to an administrator) that some received data points 210 were not ingested into time series database 130.

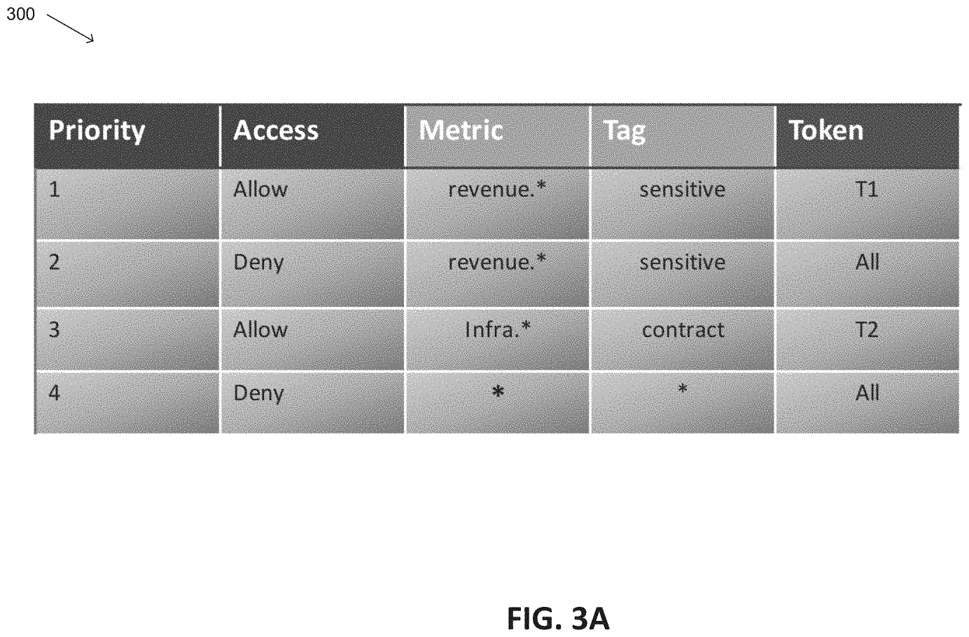

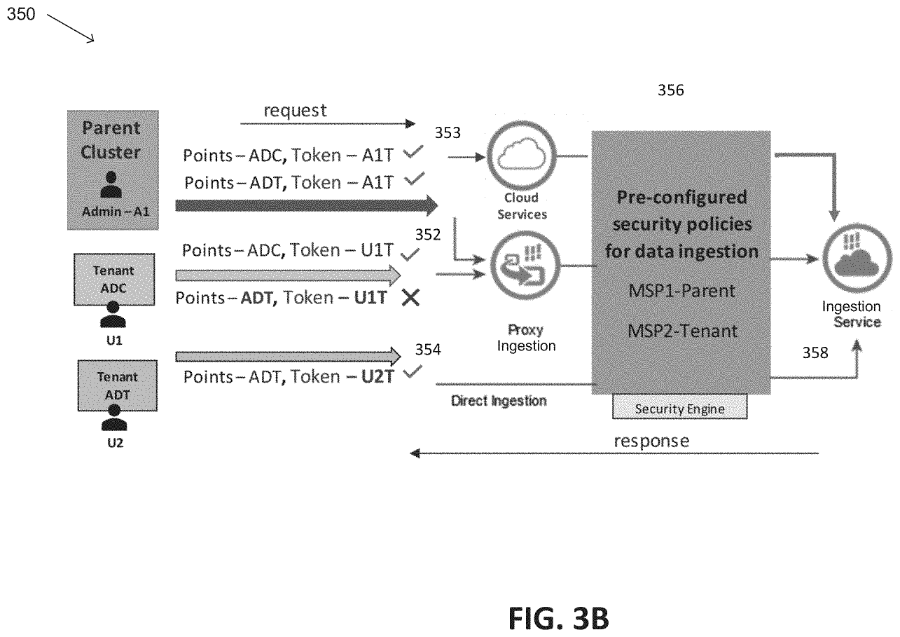

In some embodiments, a metrics security policy includes a prioritized list of security policies or rules, for ingestion, that can be ordered (and re-ordered) in such a way that policies or rules are enforced according to the ordering of the prioritized list. FIG. 3A illustrates an example prioritized list 300 for controlling ingestion of metrics (e.g., data points) into a time series database, according to embodiments. As illustrated, Priority represents the hierarchical order of the rules, Access defines whether access is allowed or denied for the rules, Metric defines a metric for which the rule applies, Tag defines a tag of a metric for which the rule applies, and Token defines the token (e.g., identifier) required for accepting the rule.

In the illustrated example, metrics starting with the prefix “revenue” (illustrated as “revenue.*”, where “*” indicates a wildcard of one or more characters) are limited to identifiers including a specific security token “T1.” Rules 1 through 4 are defined, where Rule 1 allows ingestion of a metric with prefix “revenue” or tag “sensitive” using security token “T1”, Rule 2 denies ingestion of a metric with prefix “revenue” or tag “sensitive” to all tokens, Rule 3 allows ingestion of a metric with prefix “Infra” or tag “contract” using security token “T2”, and Rule 4 denies ingestion of all metrics and all tokens. Where ingestion of a metric with the prefix “revenue” is attempted using the token T1, Rules 1 and 2 are satisfied. As Rule 1 is prioritized over Rule 2, ingestion is allowed. Where ingestion of the metric “revenue” is attempted with a token other than T1 (e.g., T3), Rules 2, 4, 5 are satisfied and ingestion of the metric using the token is denied because 2 has the highest priority.

FIG. 3B illustrates an example data flow diagram 350 for secure ingestion of metrics into a time series database, according to embodiments. In accordance with various embodiments, to secure ingestion of metrics, the security policies validate the request to ingest the metrics (e.g., data points), through multiple vehicles, e.g., either through a proxy, direct ingestion, or cloud services, against the token associated with the request to determine whether to accept or reject ingestion/storing the data points. At operation 352, the request to ingest data points along with associated token is sent through a proxy. For example, an administrator from a parent cluster ingests data points from multiple sub-tenants along with the token. User U1 from sub-tenant ADC sends a request to ingest data points from their own tenant ADC, which is allowed, and data points from a different sub-tenant ADT, which should be denied.

At operation 353, the request to ingest data points along with associated token is sent through a cloud service provider or integration. For example, a service team may use multiple cloud providers, e.g., integrations, such as AWS, Google Cloud Platform (GCP), etc. The token of the integration is registered (e.g., stored) and the external cloud service validates that token and inserts the data. User U1 from sub-tenant ADC registers the token of the integration, AWS, and ingests data from AWS, which is allowed, and data points from an integration used by a different sub-tenant ADT, which are denied because the token of the integration does not match that of the ADC integration.

At operation 354, the request to ingest data points along with associated token is sent through direct ingestion. For example, User U2 from sub-tenant ADT sends a request to ingest data points from their own tenant ADT, which is allowed. At operation 356, the requests are validated against the ingestion security policies. For example, a User U1 request to ingest ADC and ADT will result in data points ADC being ingested and ADT being dropped according to the policies defined. If there are policies or rules established in the security engine that deny ingestion of metrics by any users outside their own tenants then the corresponding data points will be dropped. At operation 358, service returns response to client. For example, data points are ingested only from their own tenants. All data points are ingested, other than data points ADT using token U1T.

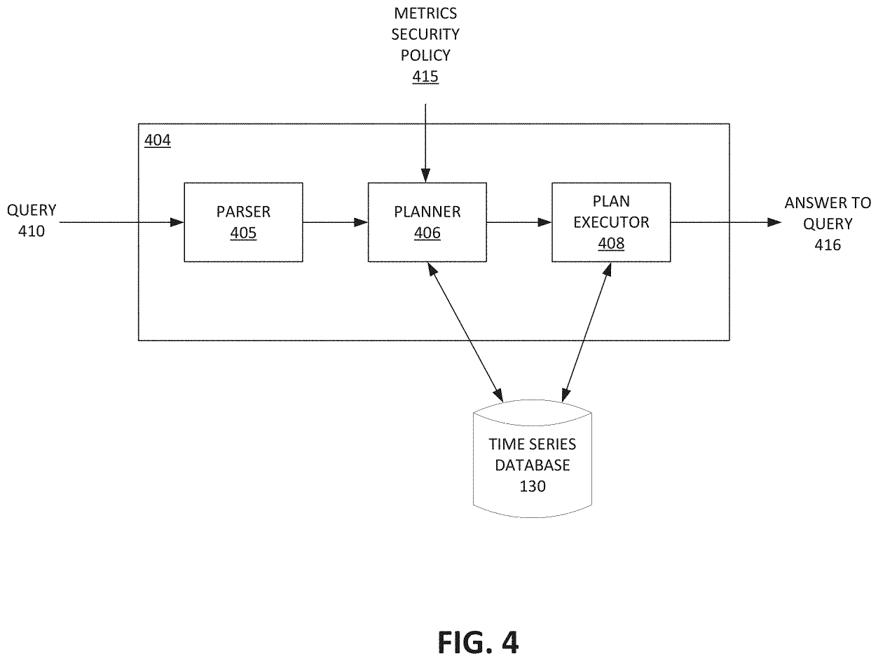

FIG. 4 is a block diagram illustrating an embodiment of example query node 404 (e.g., one of query nodes 104a through 104n of FIG. 1) for secure querying of metrics of a time series database (e.g., time series database 130), according to embodiments. In one embodiment, query node 404 generates a query plan for the time series data based on the query 410. Query node 404 includes a parser 405, a planner 406, and an executor 408. Query node 404 can be implemented by a query execution engine configured to parse a query at parser 405, produce a query execution plan at planner 406, fetch time series data and run the time series data through processing operations, and determine an answer or response to the query at executor 408.

In the example shown in FIG. 4, a query 410 is received. In one embodiment, the query 410 is provided by a user via a client. Time series data is provided by time series database 130. The data can include times series data, which may be discrete or continuous. Query 410 is received for searching the time series data and includes an identifier (e.g., a role, group, or account). A query can include elements that define searchable parameters of the time series data. For example, the query can include elements defining terms related to metrics, sources, values, timestamps, and/or point tags for isolating and returning relevant results. The parser 405 receives a query 410 and parses the query for a predicate (e.g., elements and operators). The predicate forms at least part of a basis for generating a query plan. For instance, consider the example query:
ts(“*graf*”, host=“*2*” and tag=app and (status=production or role=app) and cluster=mon and cpu=cpu-total)

The example query is parsed into the predicate including the elements and operators:
metric=“*graf*” AND
host=“*2*” AND
(status=production OR role=app) AND
cluster=mon AND
cpu=cpu-total

The planner 406 receives the parsed elements and operators of query 410 and generates a query plan for retrieval of relevant time series data that resolves the query 410. The planner 406 determines operations to be performed on the relevant time series data to retrieve a result of the query 410.

In operation, planner 406 receives a query. Planner 406 generates a query plan for determining what to retrieve from time series databases 130 based on the query. For example, planner 406 determines how many scans to make on the time series database(s). During query plan generation, planner 406 receives metrics security policy 415 (e.g., from security node 106). The query plan is validated against the metrics security policy 415, and planner 406 updates the query plan to exclude any metric indicated in the metrics security policy 415 as excluded according to the identifier.

The planner 406 then hands off commands (e.g., a query plan) to executor 408 to perform an execution phase, e.g., beginning execution of the query 410. The executor 408 then outputs an answer to the query 416. Although shown as a single stream, the answer to the query 416 can include one or more streams. In some embodiments, the answer to the query 416 includes an indication that the answer to the query 416 does not include all metrics available in time series database 130, as some metrics were excluded due to a lack of authorized access.

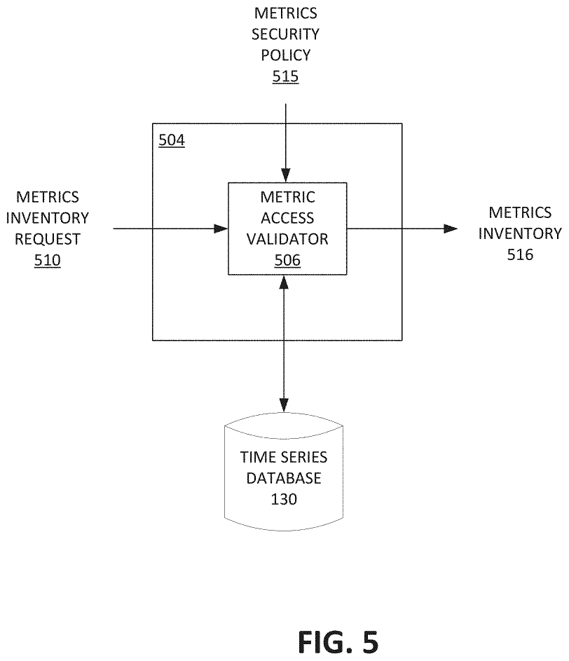

FIG. 5 is a block diagram illustrating an embodiment of example query node 504 (e.g., one of query nodes 104a through 104n of FIG. 1) for secure access to metrics of a time series database (e.g., time series database 130), according to embodiments. In one embodiment, query node 504 provides a metrics inventory 516 of the time series data based on metrics inventory request 510. Query node 504 includes a metric access validator 506. It should be appreciated that in accordance with some embodiments, metrics inventory request 510 may be interpreted by query node 504 as a query (e.g., query 410 of FIG. 4) for an inventory of metrics of time series database 130. In some embodiments, the functionality of metric access validator 506 is comprised within planner 406 of FIG. 4, as described above.

In operation, query node 504 receives a metrics inventory request 510. Metric access validator 506 receives metrics inventory request 510 and metrics security policy 515 (e.g., from security node 106). Metric access validator 506 compares metrics inventory request 510 to metrics security policy 515 to determine which metrics of metrics inventory request 510 are authorized for access by the identifier associated with metrics inventory request 510. Metrics inventory request 510 is updated to exclude metrics for which access is not authorized. Metrics inventory 516 (e.g., a list of authorized metrics) is returned as the results of metrics inventory request 510.

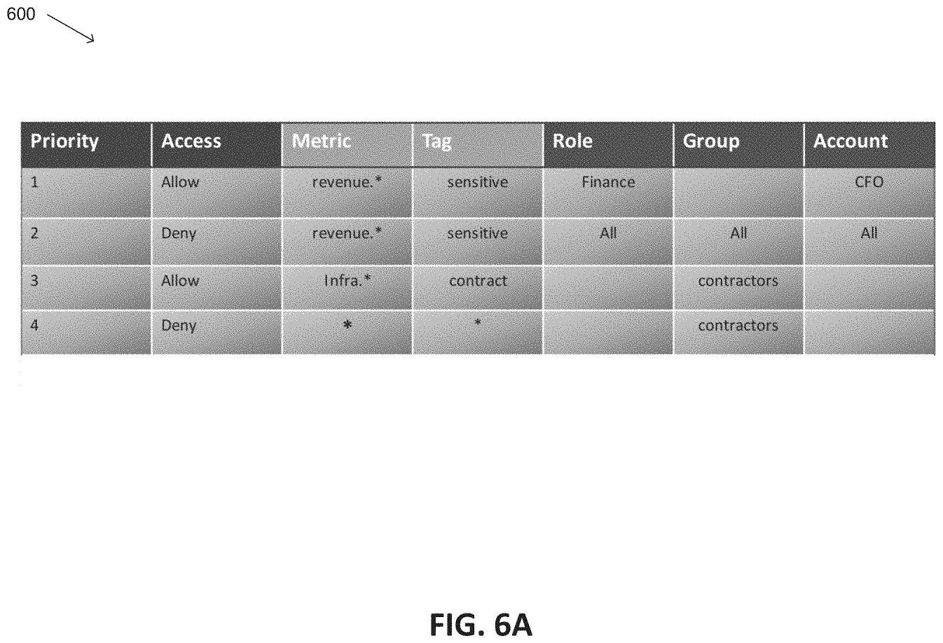

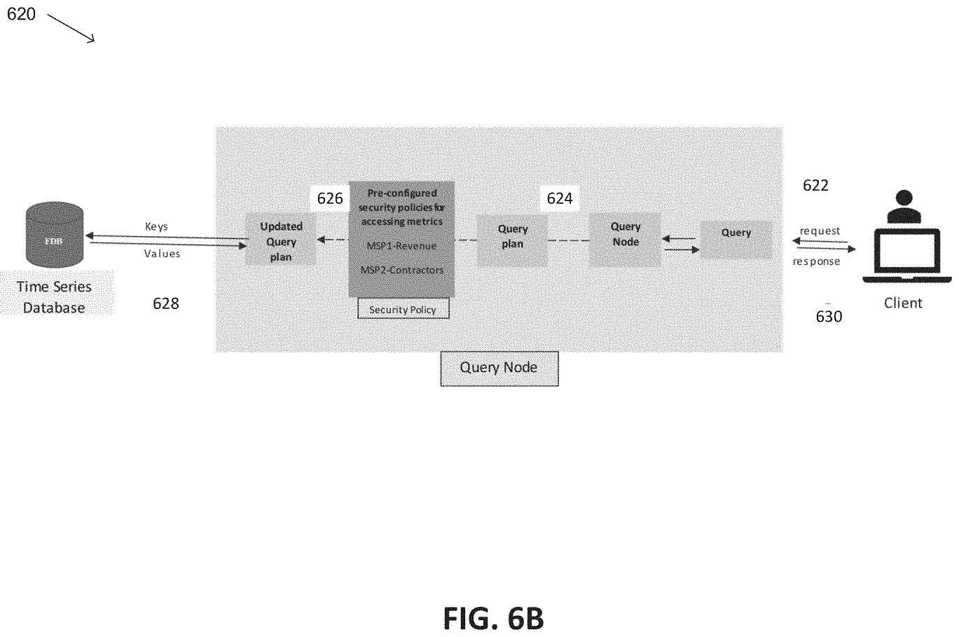

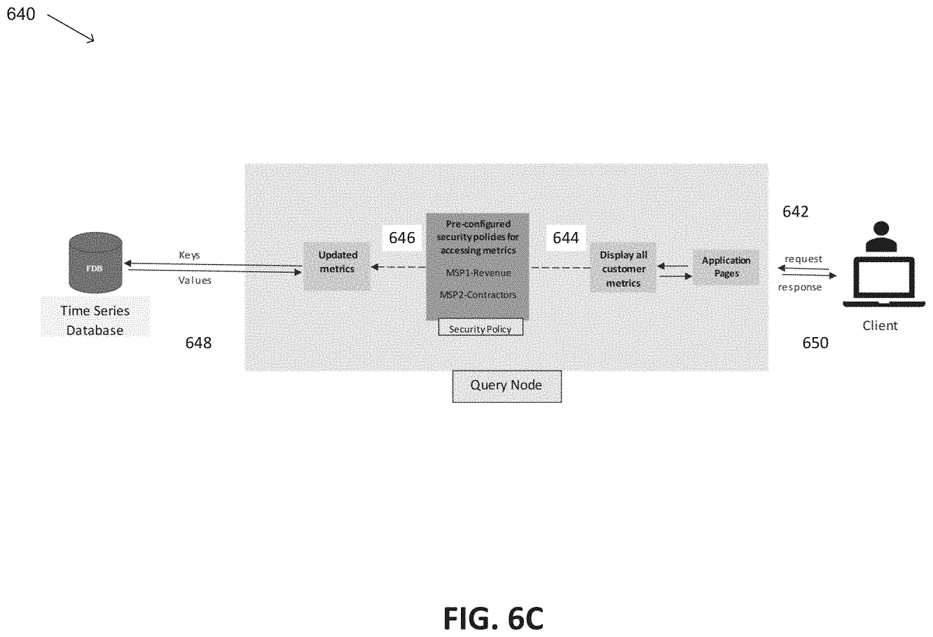

In some embodiments, a metrics security policy includes a prioritized list of security policies or rules, for ingestion, that can be ordered (and re-ordered) in such a way that policies or rules are enforced according to the ordering of the prioritized list. FIG. 6A illustrates an example prioritized list 600 of a metrics security policy for controlling access to metrics of a time series database, according to embodiments. As illustrated, Priority represents the hierarchical order of the rules, Access defines whether access is allowed or denied for the rules, Metric defines a metric for which the rule applies, Tag defines a tag of a metric for which the rule applies, and Role, Group, and Account define the identifiers associated with the rule.

In the illustrated example, Rules 1 and 2 are associated with a use case for limiting revenue-related metrics to a chief financial officer (CFO). Rule 1 allows access to the CFO account to metrics starting with the prefix “revenue” (illustrated as “revenue.*”, where “*” indicates a wildcard of one or more characters) or having the tag “sensitive”. Rule 2 denies access to metrics starting with the prefix “revenue” or having the tag “sensitive”. As Rule 1 is prioritized over Rule 2, Rule 1 is applied first on an access request, and access is authorized for access requests by the CFO account for metrics starting with the prefix “revenue” or having the tag “sensitive”.

In prioritized list 600, Rules 3 and 4 are associated with a use case where contractors are limited to access to metrics that start with a prefix “Infra” or tagged “contract”. Rule 3 allows access to the contractor group to metrics starting with the prefix “Infra” or having the tag “contract”. Rule 4 denies access to any metrics (illustrated as the wildcard “*”) to the contractor group. As Rule 3 is prioritized over Rule 4, Rule 3 takes precedence over rule 4, and allows the contractor group to access metrics starting with the prefix “Infra” or having the tag “contract”. In the same context, if a member of the contractor group attempts to access any metric other than metrics starting with the prefix “Infra”, access will be denied as none of the rules allowing access to data (Rules 1 and 3) will be satisfied.

FIG. 6B illustrates an example data flow diagram 620 for secure querying of metrics of a time series database, according to embodiments. At operation 622, a client requests a query and the query is received at a query node (e.g., query node 104 or 404). For example, a contractor executes a query for metrics with prefix “revenue”. At operation 624, the query node generates a query plan that is validated against the set of metrics access policies. For example, the query plan is validated against a security policy that denies access of metrics with “revenue” prefix to contractors. At operation 626, the query plan is updated to request for metrics excluding ones denied access by the security policy. For example, the query plan is updated to fetch metrics excluding ones with “revenue” prefix. At procedure 628, key value pairs are returned from index and data nodes (e.g., from the time series database). Continuing with the example, zero results are fetched as the contractor group does not have access to metrics with “revenue” prefix. At operation 630, results are returned to the client. In the current example, no results are returned since the access is denied. In some embodiments, the client may be informed that access to some metrics was denied.

FIG. 6C illustrates an example data flow diagram 630 for secure access to metrics of a time series database, according to embodiments. At operation 642, an application page sends a request for displaying all metrics. For example, a metrics browser is accessed for displaying customer metrics. At operation 644, the request along with associated identifier is validated against the existing security policies. For example, if an engineer is accessing the metrics browser for viewing customer metrics, the user account is validated along with the request for metrics. At operation 646, the list of metrics to fetch are updated. For example, if there are security policies that deny access of “revenue” metrics to anyone except the CFO, then the list of metrics to fetch are updated to exclude metrics with prefix “revenue”. At procedure 648, key value pairs are returned from index and data nodes (e.g., from the time series database). Continuing with the example, metrics excluding those with the “revenue” prefix are retrieved. At operation 650, results are returned to the client. In the current example, all metrics except metrics with prefix “revenue” are displayed to the engineer.

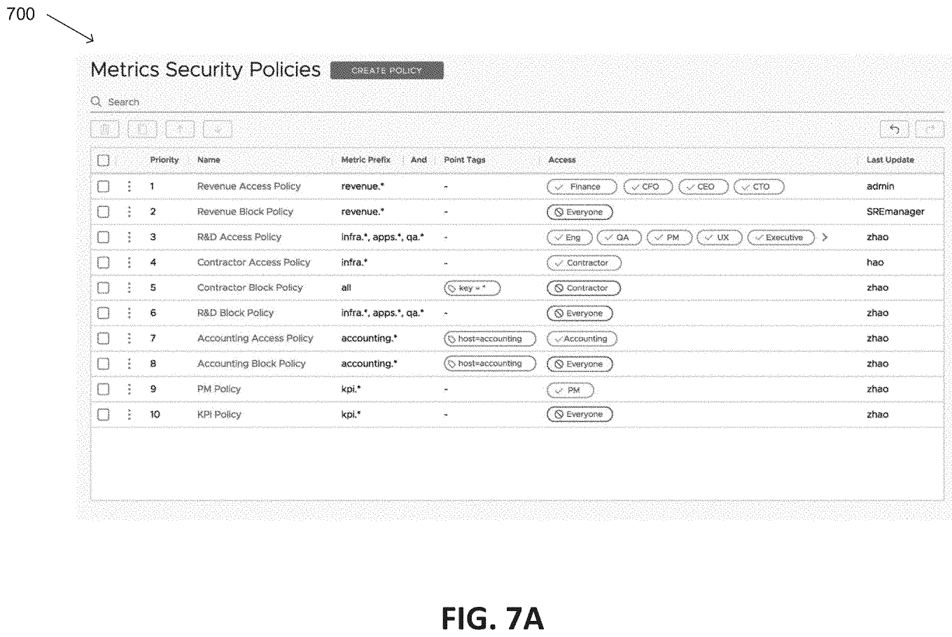

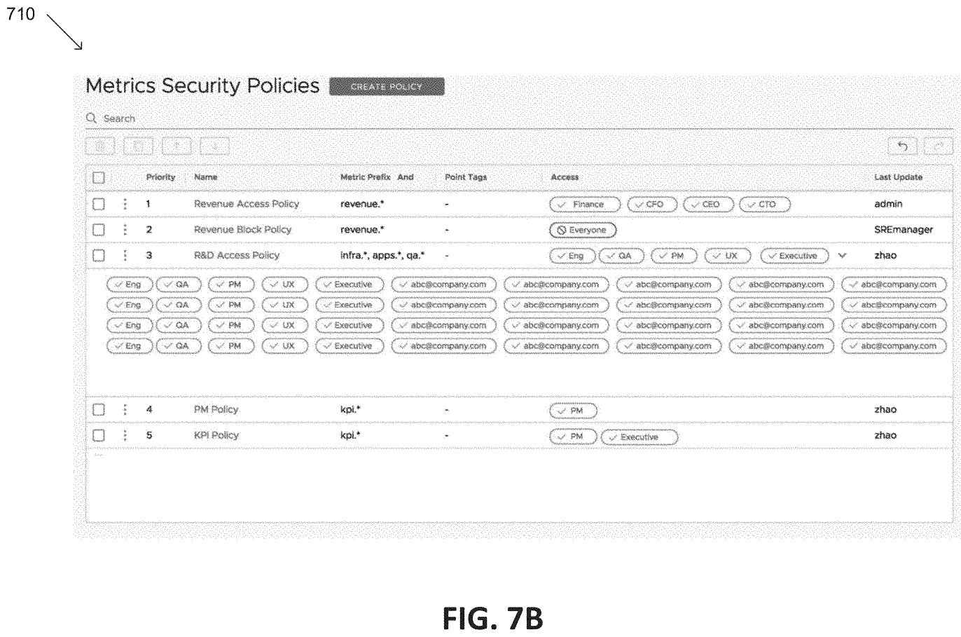

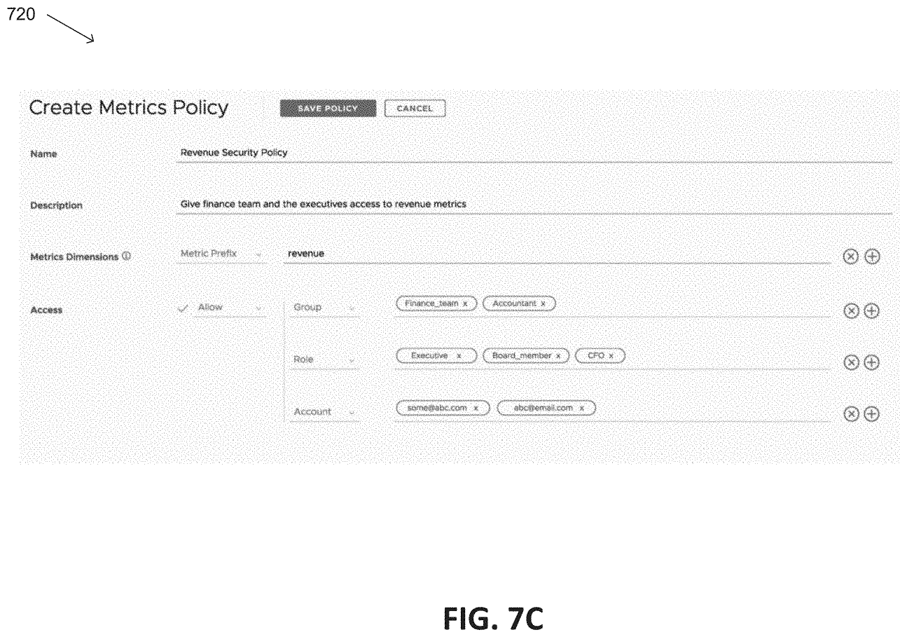

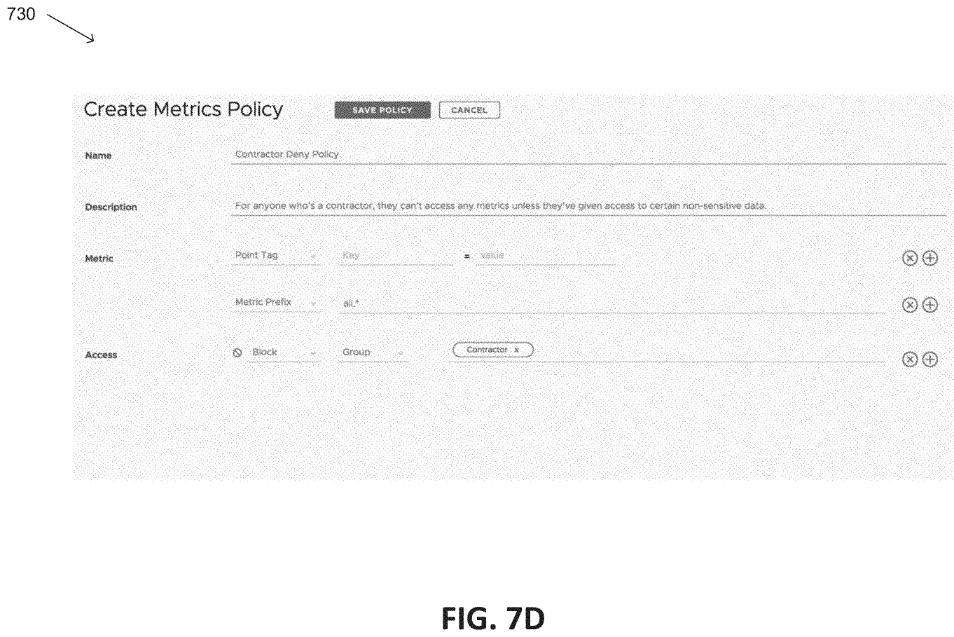

FIGS. 7A through 7D illustrate screen shots of an example metric security policy creation user interface, according to embodiments. FIG. 7A illustrates example screen shot 700 of a prioritized list of metric security policies. The list is ordered according to priority, such that higher priority rules (lower number) have precedence over lower priority rules (higher number). The rules each include a name, a metric prefix to which the rule is applied, optional points tags to which the rules is applied, and an access policy indicating to whom the rule applies. FIG. 7B illustrates example screen shot 710 that shows an expanded view of the access selection of the R&D Access Policy rule for selection of who the rule is applied to. FIG. 7C illustrates example screen shot 720 of a Create Metrics Policy for allowing access to the metric “revenue”. FIG. 7D illustrates example screen shot 730 of a Create Metrics Policy for denying access to the all metrics for the Contractor group.

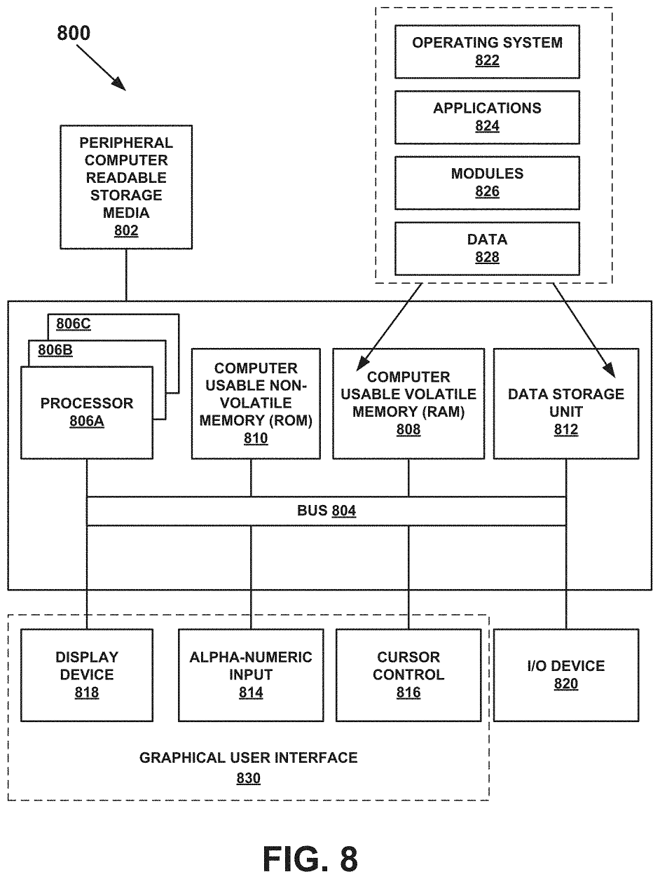

FIG. 8 is a block diagram of an example computer system 800 upon which embodiments of the present invention can be implemented. FIG. 8 illustrates one example of a type of computer system 800 (e.g., a computer system) that can be used in accordance with or to implement various embodiments which are discussed herein.

It is appreciated that computer system 800 of FIG. 8 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 800 of FIG. 8 is well adapted to having peripheral tangible computer-readable storage media 802 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 800 of FIG. 8 includes an address/data bus 804 for communicating information, and a processor 806A coupled with bus 804 for processing information and instructions. As depicted in FIG. 8, computer system 800 is also well suited to a multi-processor environment in which a plurality of processors 806A, 806B, and 806C are present. Conversely, computer system 800 is also well suited to having a single processor such as, for example, processor 806A. Processors 806A, 806B, and 806C may be any of various types of microprocessors. Computer system 800 also includes data storage features such as a computer usable volatile memory 808, e.g., random access memory (RAM), coupled with bus 804 for storing information and instructions for processors 806A, 806B, and 806C. Computer system 800 also includes computer usable non-volatile memory 810, e.g., read only memory (ROM), coupled with bus 804 for storing static information and instructions for processors 806A, 806B, and 806C. Also present in computer system 800 is a data storage unit 812 (e.g., a magnetic or optical disc and disc drive) coupled with bus 804 for storing information and instructions. Computer system 800 also includes an alphanumeric input device 814 including alphanumeric and function keys coupled with bus 804 for communicating information and command selections to processor 806A or processors 806A, 806B, and 806C. Computer system 800 also includes a cursor control device 816 coupled with bus 804 for communicating user input information and command selections to processor 806A or processors 806A, 8066, and 806C. In one embodiment, computer system 800 also includes a display device 818 coupled with bus 804 for displaying information.

Referring still to FIG. 8, display device 818 of FIG. 8 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 816 allows the computer user to dynamically signal the movement of a visible symbol (cursor) on a display screen of display device 818 and indicate user selections of selectable items displayed on display device 818. Many implementations of cursor control device 816 are known in the art including a trackball, mouse, touch pad, touch screen, joystick or special keys on alphanumeric input device 814 capable of signaling movement of a given direction or manner of displacement. Alternatively, it will be appreciated that a cursor can be directed and/or activated via input from alphanumeric input device 814 using special keys and key sequence commands. Computer system 800 is also well suited to having a cursor directed by other means such as, for example, voice commands. In various embodiments, alphanumeric input device 814, cursor control device 816, and display device 818, or any combination thereof (e.g., user interface selection devices), may collectively operate to provide a graphical user interface (GUI) 830 under the direction of a processor (e.g., processor 806A or processors 806A, 806B, and 806C). GUI 830 allows user to interact with computer system 800 through graphical representations presented on display device 818 by interacting with alphanumeric input device 814 and/or cursor control device 816.

Computer system 800 also includes an I/O device 820 for coupling computer system 800 with external entities. For example, in one embodiment, I/O device 820 is a modem for enabling wired or wireless communications between computer system 800 and an external network such as, but not limited to, the Internet. In one embodiment, I/O device 820 includes a transmitter. Computer system 800 may communicate with a network by transmitting data via I/O device 820.

Referring still to FIG. 8, various other components are depicted for computer system 800. Specifically, when present, an operating system 822, applications 824, modules 826, and data 828 are shown as typically residing in one or some combination of computer usable volatile memory 808 (e.g., RAM), computer usable non-volatile memory 810 (e.g., ROM), and data storage unit 812. In some embodiments, all or portions of various embodiments described herein are stored, for example, as an application 824 and/or module 826 in memory locations within RAM 808, computer-readable storage media within data storage unit 812, peripheral computer-readable storage media 802, and/or other tangible computer-readable storage media.

### Example Methods of Operation

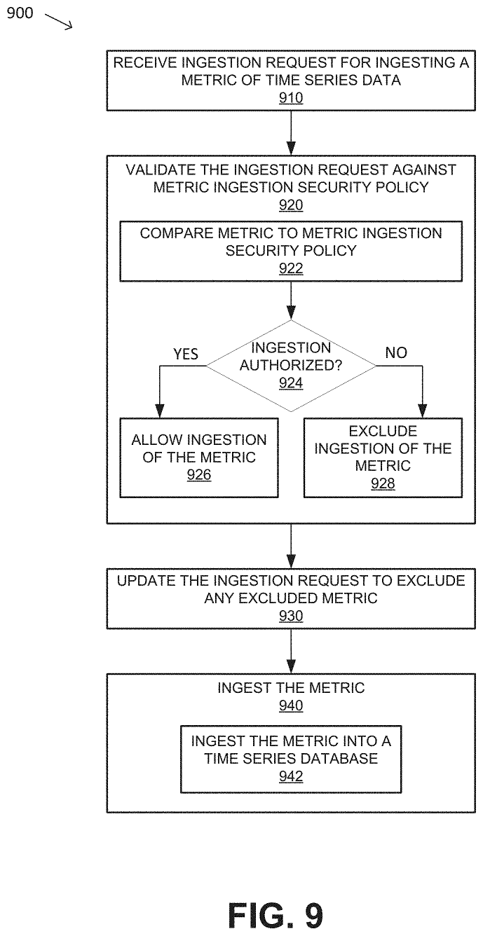

The following discussion sets forth in detail the operation of some example methods of operation of embodiments. With reference to FIGS. 9, 10, and 11, flow diagrams 900, 1000, and 1100 illustrate example procedures used by various embodiments. Flow diagrams 900, 1000, and 1100 of FIGS. 5 through 10 include some procedures that, in various embodiments, are carried out by a processor under the control of computer-readable and computer-executable instructions. In this fashion, procedures described herein and in conjunction with flow diagrams 900, 1000, and 1100 are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 800). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in flow diagrams 900, 1000, and 1100, such procedures are examples. That is, embodiments are well suited to performing various other procedures or variations of the procedures recited in flow diagrams 900, 1000, and 1100. Likewise, in some embodiments, the procedures in flow diagrams 900, 1000, and 1100 of FIGS. 9, 10, and 11 may be performed in an order different than presented and/or not all of the procedures described in one or more of flow diagrams 900, 1000, and 1100 may be performed. It is further appreciated that procedures described in flow diagrams 900, 1000, and 1100 of FIGS. 9, 10, and 11 may be implemented in hardware, or a combination of hardware with firmware and/or software provided by computer system 800.

FIG. 9 illustrates a flow diagram 900 for secure ingestion of metrics of time series data, according to various embodiments. At procedure 910 of FIG. 9, an ingestion request for ingesting at least one metric of time series data is received, the ingestion request comprising an identifier. In one embodiment, the ingestion request is received via a proxy. In one embodiment, the ingestion request is received via a directed ingestion. In one embodiment, the identifier includes a token.

At procedure 920, the ingestion request is validated against a metric ingestion security policy according to the identifier. In one embodiment, the metric ingestion security policy comprises a prioritized list of security policies for ingestion, wherein the security policies are enforced according to an order of the prioritized list. In one embodiment, as shown at procedure 922, the at least one metric of the ingestion request is compared to the metric ingestion security policy. At procedure 924, it is determined, based on the comparison, whether ingestion of the metric is authorized. Provided ingestion of the metric is authorized, as shown at procedure 926, ingestion of the metric is allowed. Provided ingestion of the metric is not authorized, as shown at procedure 928, ingestion of the metric is excluded.

At procedure 930, the ingestion request is updated to exclude any metric indicated in the metric ingestion security policy as excluded according to the identifier. At procedure 940, the at least one metric of time series data is ingested according to the ingestion request. In one embodiment, as shown at procedure 942, the at least one metric is ingested into a time series database.

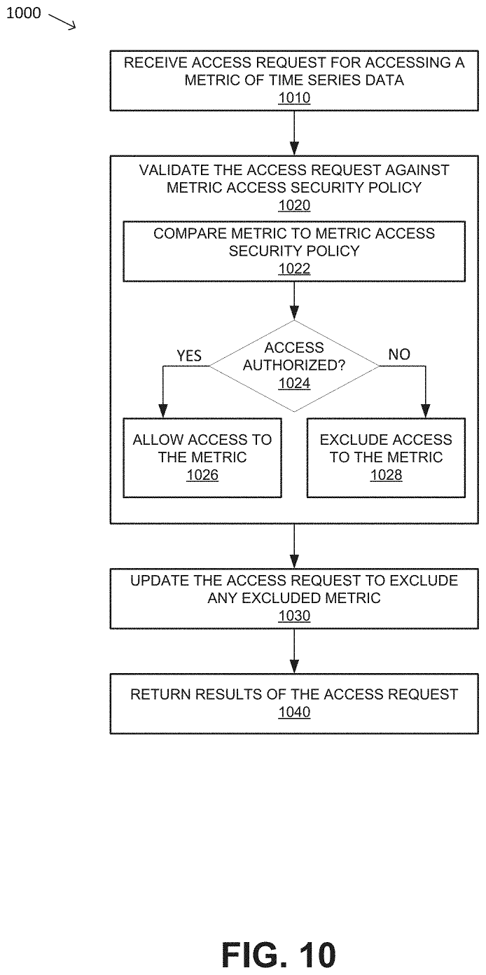

FIG. 10 illustrates a flow diagram 1000 for secure access to metrics of time series data, according to various embodiments. At procedure 1010 of FIG. 10, an access request for accessing at least one metric of time series data is received, the access request comprising an identifier. In one embodiment, the access request comprises a request for displaying a plurality of metrics, e.g., an inventory of the metrics. In another embodiment, the access request comprises a query request for accessing the at least one metric of time series data. In one embodiment, the identifier comprises at least one of: an account, a role, and a group.

At procedure 1020, the access request is validated against a metric access security policy according to the identifier. In one embodiment, the metric access security policy comprises a prioritized list of rules for accessing metrics from at least one time series database, wherein the security policies are enforced according to an order of the prioritized list. In one embodiment, as shown at procedure 1022, the at least one metric of the access request is compared to the metric access security policy. At procedure 1024, it is determined, based on the comparison, whether access to the metric is authorized. Provided access to the metric is authorized, as shown at procedure 1026, access to the metric is allowed. Provided access of the metric is not authorized, as shown at procedure 1028, access to the metric is excluded.

At procedure 1030, the access request is updated to exclude any metric indicated in the metric access security policy as excluded according to the identifier. At procedure 1040, results of the access request are returned, e.g., an inventory of the metrics. In one embodiment, the results comprise key value pairs from at least one time series database.

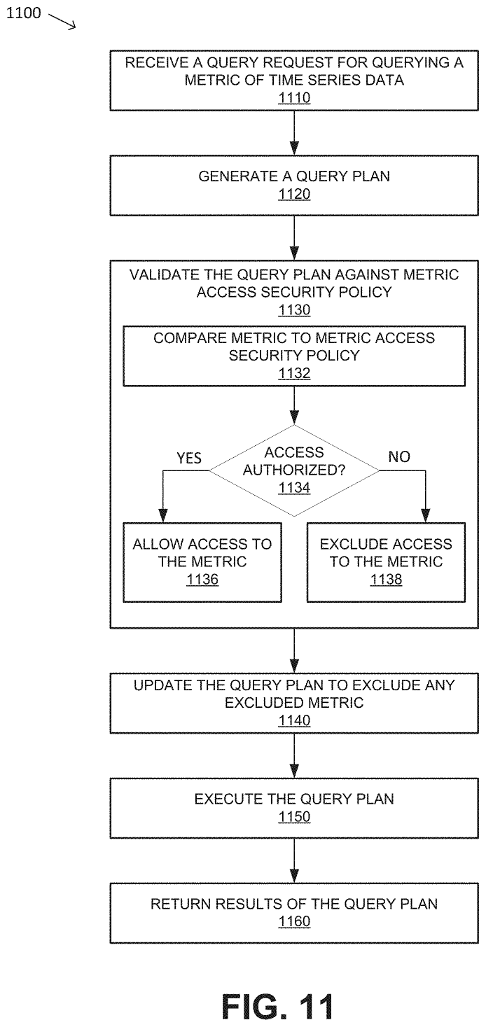

FIG. 11 illustrates a flow diagram 1100 for secure querying of metrics of time series data, according to various embodiments. At procedure 1110 of FIG. 11, an query request for querying at least one metric of time series data is received, the query request comprising an identifier. In one embodiment, the identifier comprises at least one of: an account, a role, and a group.

At procedure 1120, a query plan for accessing the at least one metric of time series data from at least one time series database is generated. At procedure 1130, the query plan is validated against a metric access security policy according to the identifier. In one embodiment, the metric access security policy comprises a prioritized list of security policies for access, wherein the security policies are enforced according to an order of the prioritized list. In one embodiment, as shown at procedure 1132, the at least one metric of the access request is compared to the metric access security policy. At procedure 1134, it is determined, based on the comparison, whether access to the metric is authorized. Provided access to the metric is authorized, as shown at procedure 1136, access to the metric is allowed. Provided access of the metric is not authorized, as shown at procedure 1138, access to the metric is excluded.

At procedure 1140, the query plan is updated to exclude any metric indicated in the metric access security policy as excluded according to the identifier. At procedure 1150, the query plan is executed. At procedure 1160, results of the query plan are returned. In one embodiment, the results comprise key value pairs from at least one time series database.

It is noted that any of the procedures, stated above, regarding flow diagrams 900, 1000, and 1100 of FIGS. 9, 10, and 11 may be implemented in hardware, or a combination of hardware with firmware and/or software. For example, any of the procedures are implemented by a processor(s) of a cloud environment and/or a computing environment.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method for secure ingestion of metrics of time series data, the method comprising:
receiving an ingestion request for ingesting at least one metric of time series data, the ingestion request comprising an identifier;
validating the ingestion request against a metric ingestion security policy according to the identifier;
updating the ingestion request to exclude any metric indicated in the metric ingestion security policy as excluded according to the identifier; and
ingesting the at least one metric of time series data according to the ingestion request.

2. The method of claim 1, wherein the ingestion request is received via a proxy.

3. The method of claim 1, wherein the ingestion request is received via a direct ingestion.

4. The method of claim 1, wherein the ingestion request is received via an external integration.

5. The method of claim 1, wherein the metric ingestion security policy comprises a prioritized list of security policies for ingestion, wherein the security policies are enforced according to an order of the prioritized list.

6. The method of claim 1, wherein the identifier comprises a token.

7. The method of claim 1, wherein the validating the ingestion request against a security policy according to the identifier comprises:
comparing the at least one metric of the ingestion request to the metric ingestion security policy;
determining whether the metric ingestion security policy authorizes ingestion of the at least one metric for the identifier; and
provided the metric ingestion security policy does not authorize ingestion of the at least one metric for the identifier, determining that ingestion of the at least one metric is excluded.

8. The method of claim 1, wherein the ingesting the at least one metric of time series data according to the ingestion request comprises:
ingesting the at least one metric of time series data into at least one time series database.

9. A non-transitory computer readable storage medium having computer readable program code stored thereon for causing a computer system to perform a method for secure ingestion of metrics of time series data, the method comprising:
receiving an ingestion request for ingesting at least one metric of time series data, the ingestion request comprising an identifier;
validating the ingestion request against a metric ingestion security policy according to the identifier;
updating the ingestion request to exclude any metric indicated in the metric ingestion security policy as excluded according to the identifier; and
ingesting the at least one metric of time series data according to the ingestion request.

10. The non-transitory computer readable storage medium of claim 9, wherein the ingestion request is received via a proxy.

11. The non-transitory computer readable storage medium of claim 9, wherein the ingestion request is received via a direct ingestion.

12. The non-transitory computer readable storage medium of claim 9, wherein the ingestion request is received via an external integration.

13. The non-transitory computer readable storage medium of claim 9, wherein the metric ingestion security policy comprises a prioritized list of security policies for ingestion, wherein the security policies are enforced according to an order of the prioritized list.

14. The non-transitory computer readable storage medium of claim 9, wherein the identifier comprises a token.

15. The non-transitory computer readable storage medium of claim 9, wherein the validating the ingestion request against a security policy according to the identifier comprises:
comparing the at least one metric of the ingestion request to the metric ingestion security policy;
determining whether the metric ingestion security policy authorizes ingestion of the at least one metric for the identifier; and
provided the metric ingestion security policy does not authorize ingestion of the at least one metric for the identifier, determining that ingestion of the at least one metric is excluded.

16. The non-transitory computer readable storage medium of claim 9, wherein the ingesting the at least one metric of time series data according to the ingestion request comprises:
ingesting the at least one metric of time series data into at least one time series database.

17. A system for securing ingestion of metrics of time series data, the system comprising:
a data storage unit; and
a processor communicatively coupled with the data storage unit, the processor configured to:
receive an ingestion request for ingesting at least one metric of time series data, the ingestion request comprising an identifier;
validate the ingestion request against a metric ingestion security policy according to the identifier;
update the ingestion request to exclude any metric indicated in the metric ingestion security policy as excluded according to the identifier; and
ingest the at least one metric of time series data according to the ingestion request.

18. The system of claim 17, wherein the metric ingestion security policy comprises a prioritized list of security policies for ingestion, wherein the security policies are enforced according to an order of the prioritized list.

19. The system of claim 17, wherein the processor is further configured to:
compare the at least one metric of the ingestion request to the metric ingestion security policy;
determine whether the metric ingestion security policy authorizes ingestion of the at least one metric for the identifier; and
determine that ingestion of the at least one metric is excluded provided the metric ingestion security policy does not authorize ingestion of the at least one metric for the identifier.

20. The system of claim 17, wherein the processor is further configured to:
ingest the at least one metric of time series data into at least one time series database.
